(19) United States
(12) Patent Application Publication
(10) Pub. No.: US 2004/0044591 A1
(43) Pub. Date: Mar. 4, 2004

(54) Method and system for electronic procurement involving electronic requests for quotation

(76) Inventors: Ramelle L. Gilliland, Royal Oak, MI (US); Lisa M. Howick, Canton, MI (US); Deborah L. Barber, Canton, MI (US); Susan L. Bjoraker, Canton, MI (US); Holly Flory, Commerce Township, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/464,358

(22) Filed: Jun. 18, 2003

Related U.S. Application Data
(60) Provisional application No. 60/389,841, filed on Jun. 19, 2002.

(51) Int. Cl. G06F 17/60

(52) U.S. Cl. 705/27

(57) ABSTRACT

According to an embodiment of the present invention, a computer-implemented method for electronic procurement for multiple plants involving electronic requests for quotation is disclosed. The method includes receiving sourcing information, transmitting the sourcing information to one or more buyers, transmitting an electronic request for quotation (eRFQ) based on the sourcing information to one or more suppliers, and receiving one or more quotations for the part being potentially supplied to the multiple plants from each of the one or more suppliers through a quote management tool interface.

### CROSS-REFERENCE TO RELATED APPLICATIONS

This application claims the benefit of U.S. provisional application Serial No. 60/389,841, filed Jun. 19, 2002, and entitled “Method and System For Electronic Procurement Involving Electronic Requests For Quotation”.

### BACKGROUND OF THE INVENTION

1. Field of the Invention

One of the aspects of the present invention relates generally to a method and system for electronic procurement involving electronic requests for quotation and, more specifically, a method and system for electronic procurement with respect to global suppliers providing goods and services to multiple lead operating units.

2. Background Art

A distributed enterprise is an organization having multiple lead operating units spread across a geographic region, continent or globe. In today's business environment, thousands of businesses have lead operating units facilities located in more than one country or continent. For example, an automobile manufacturer may have multiple management facilities, engineering facilities, manufacturing facilities, assembly facilities, distribution facilities, sales facilities and service facilities located within most countries and every continent on the planet. Each of these facilities must, in turn, deal with a second-tier of often equally-distributed supplier communities.

Distributed enterprises present a unique challenge to conventional electronic procurement management software. Most procurement systems are tailored to effectively meet the needs of smaller to mid-sized businesses having a few, if any, distributed business operating units or supplier base. However, these conventional systems lack functionality to effectively support certain business needs of large to very large companies with multiple lead operating units that are distributed across a wide geographical range.

For years, electronic data interchange (EDI) and virtual private network (VPN) technologies have enabled businesses and their suppliers to exchange invoices, purchase orders, and other documents to conduct their day-to-day business online. Typically, these systems were proprietary in nature, required a dedicated technical infrastructure, and required a costly subscription or pay-per-use access arrangement.

The advent of the Internet has revolutionized electronic procurement systems by increasing the speed and decreasing the costs associated with the first-generation systems. Without such access barriers, buyers are presented with a broader horizon of potential suppliers. Today, a buyer organization can access the Internet to obtain pricing information, product and service information, submit a purchase request, route the request for approval, view the fulfillment status of the request, receive a receipt and delivery notification, and transmit payment.

According to one IDC survey conducted in September 2000, the amount of savings generated with the use of an Internet-enabled procurement system will, on average, range from 5.0% to 8.5% of a company's purchasing budget. Depending on the size of the company, this savings can translate to over a billion dollars annually.

In the manufacturing industry, resource demand can be generalized into two broad categories: direct and indirect. Direct procurement includes the purchasing of resources that make up the product ultimately being manufactured. Indirect procurement includes the purchasing of “support” resources that are necessary to bring about the manufacture of the product. In an automobile manufacturing example, a direct resource might be the paint or windshield for a particular automobile. An indirect resource might include a day-to-day commodity such as wrenches or safety glasses that, although not technically a part of the automobile, are indirectly necessary to manufacture the automobile.

Today, companies such as General Electric and Compaq Computer have integrated electronic procurement systems to streamline the online sourcing and purchasing of direct and indirect materials. For example, Compaq Computer employees can use their Web browser to view an online supplier catalog of over 37,000 items, and easily purchase the resources necessary to satisfy their day-to-day needs. Companies such as Compaq can expand this functionality to increase the variety of resources available, rationalize its supply base, and consolidate its supply chain in an effort to leverage purchase volumes into fewer suppliers and improve its relationship with a preferred supply base.

One electronic procurement application is Oracle Procurement. A detailed description of the Oracle Procurement application can be found at www.oracle.com. Other developers of procurement solutions include Ariba (www.ariba.com), i2 (www.i2.com), CommerceOne (www.commerceone.com), SAP (www.sap.com) and PeopleSoft (www.peoplesoft.com).

Issued U.S. patents relating to electronic procurement applications and systems include U.S. Pat. No. 5,970,475 to Barnes et al. and U.S. Pat. No. 6,363,365 to Kou. Published U.S. patent applications relating to electronic procurement applications and systems include U.S. patent application No. 2001/0042050 to Fletcher et al. Additional information relating to electronic procurement systems includes Albert Pang's IDC White Paper eProcurement Ensures Visionary Companies a Place in the New Economy, July 2001.

As comprehensive and beneficial as today's procurement systems may be, there still remains a wide horizon for improvement. For example, Oracle Sourcing 6.2.2 (a module of Oracle Procurement), does not provide the flexibility to conduct detailed requests for quotation from which the buyer user can model the analysis and the supply base user can provide unique and dynamic responses to RFQS.

### SUMMARY OF THE INVENTION

According to a first embodiment of the present invention, a computer-implemented method for electronic procurement for multiple plants involving electronic requests for quotation is disclosed. The method includes receiving sourcing information, transmitting the sourcing information to one or more buyers, transmitting an electronic request for quotation (eRFQ) based on the sourcing information to one or more suppliers, and receiving one or more quotations for the part being potentially supplied to the multiple plants from each of the one or more suppliers through a quote management tool interface.

The sourcing information includes a part description for a part and a first and second plant description for a first and second plant needing the part. According to the first embodiment, the first and second plants existing in a first and second operating unit, respectively. The eRFQ includes an attribute table having at least one line item. Each of the one or more quotations can include a first part price for supply to the first plant and a second part price for supply to the second plant and the first and second part prices can be different. The one or more quotations can be relied upon for selecting one of the one or more suppliers for procurement of the part for the first and second plants.

The method can further include creating a first and second purchase order for the first and second plants needing the part based on the electronic request for quotation and the one of more quotations.

In certain embodiments, one of the one or more suppliers is comprised of a supplier operating unit. Furthermore, the supplier operating unit is comprised of two or more supplier sites. The electronic request for quotation can be transmitted to the two or more supplier sites. The two or more supplier sites can transmit an at least first and second supplier site quotation to the one or more buyers.

The quote management tool can include functionality for adding at least one new line item to the attribute table. The method can further include transmitting a revised eRFQ based on the sourcing information and the one or more quotations to the one or more suppliers. The revised eRFQ can include a revised attribute table having at least one revised line item.

The method can further include receiving one or more revised quotations for the part being potentially supplied to the first and second plants from each of the one or more suppliers through the quote management tool interface. The method can further include causing display of the one or more quotations and the one or more revised quotations.

Furthermore, the method can further include at least partially importing the attribute table from the eRFQ into a revised eRFQ if the part has gone through a design change.

Each of the one or more suppliers can transmit two or more quotations for the part being potentially supplied through the quote management tool interface. The quote management tool can include functionality to receive an approval of an eRFQ recap based on two or more approval hierarchies.

The eRFQ can include an at least one index price. The part price can be adjusted automatically based on the at least one index price. The method can further include determining a price effective date for the part, the first plant, and/or the second plant. The attribute table can include a cost breakdown. The cost breakdown can include a duty uplift price and a freight cost. The cost breakdown can include a volume supplied per plant per supplier and a tooling price per supplier.

The method can further include receiving an interim price onto the at least one line item. The method can further include issuing a purchase order based on the interim price. The method can further include replacing the interim price with a firm price.

According to a second embodiment of the present invention, a computer-implemented method for component level electronic procurement involving electronic requests for quotation is disclosed. The method includes receiving sourcing information for a lead component and one or more sub-components, transmitting the sourcing information to one or more buyers, transmitting an electronic request for quotation (eRFQ) based on the sourcing information to one or more tier one suppliers and one or more tier two suppliers, receiving one or more quotations for the lead component and the one or more sub-components being potentially supplied from each of the one or more tier one suppliers for the lead component and each of the one or more tier two suppliers for the one or more sub-components through a quote management tool interface. The one or more quotation can be relied upon for selecting one of the one or more tier one suppliers for procurement of the lead component and one of the one or more tier two suppliers for procurement of the one or more sub-components. The sourcing information includes a part description for the lead component and the one or more sub-components. The eRFQ can include an attribute table having at least one line item.

According to the second embodiment, the relationship between the lead component and the one or more sub-components are defined as one or more component attributes to the at least one line item. The method can further include maintaining a component-level bill of materials based on the attribute table.

According to a third embodiment of the present invention, a computer-implemented method for electronic procurement involving electronic requests for quotation is disclosed. The method includes receiving sourcing information, the sourcing information including a part description for a part and a plant description for an at least one plant needing the part, transmitting the sourcing information to one or more buyers, transmitting an electronic request for quotation (eRFQ) based on the sourcing information to a first and second supplier, receiving a first quotation for the part being potentially supplied to the plant from the first supplier through a quote management tool interface, the first quotation including a first quotation price, receiving a second quotation for the part being potentially supplied to the plant from the second supplier through the quote management tool interface, the second quotation including a second quotation price, causing display of the first and second quotations through an eRFQ recap tool interface for comparing the first and second quotations. The first and second quotations can be relied upon for selecting the first or second supplier for procurement of the part. The eRFQ can include an attribute table having at least one line item.

According to the third embodiment, the eRFQ recap tool interface includes functionality to determine an annual total dollar impact for parts supplied by the first and/or second supplier. The method can further include receiving a price variance for the part and causing display of a carryover part price based on the variance. The first and second suppliers can quote based on the variance. The eRFQ recap tool interface can include functionality to create a recap based on the carryover part price and causing display of the carryover part price and the variance. The eRFQ recap tool interface includes functionality to cause comparison of the first and second quotations through the at least one line item. Additionally, the eRFQ recap tool interface can include functionality to receive an order issue for the selected supplier, the order issue being a purchase order or a tool order.

According to a fourth embodiment of the present invention, a computer-implemented system for electronic procurement for multiple plants involving electronic requests for quotation is disclosed. The system includes at least one server computer for communicating with at least one client computer. The at least one server computer can be configured to receive sourcing information, transmit the sourcing information to one or more buyers, transmit an electronic request for quotation (eRFQ) based on the sourcing information to one or more suppliers, and receive one or more quotations for the part being potentially supplied to the first and second plants from each of the one or more suppliers through a quote management tool interface. The sourcing information includes a part description for a part and a first and second plant description for a first and second plant needing the part. The first and second plants can exist in a first and second operating unit. The eRFQ can include an attribute table having at least one line item. Each of the one or more quotations can include a first part price for supply to the first plant and a second part price for supply to the second plant. The first and second part prices can be different. The one or more quotations can be relied upon for selecting one of the one or more suppliers for procurement of the part for the first and second plants.

According to a fifth embodiment of the present invention, a program for controlling a computer of a server electronic procurement for multiple plants involving electronic requests for quotation is disclosed. The program includes instructions for receiving sourcing information, instructions for transmitting the sourcing information to one or more buyers, instructions for transmitting an electronic request for quotation (eRFQ) based on the sourcing information to one or more suppliers, and instructions for receiving one or more quotations for the part being potentially supplied to the first and second plants from each of the one or more suppliers through a quote management tool interface. The one or more quotations can be relied upon for selecting one of the one or more suppliers for procurement of the part for the first and second plants. The sourcing information can include a part description for a part and a first and second plant description for a first and second plant needing the part. The first and second plants can exist in a first and second operating unit, respectively. The eRFQ can including an attribute table having at least one line item. Each of the one or more quotations can include a first part price for supply to the first plant and a second part price for supply to the second plant. The first and second part prices can be different.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings:

FIG. 1 is a block flow diagram illustrating an overview of an eRFQ process;

FIG. 2 is a schematic diagram illustrating a system embodiment for implementing certain embodiments of the present invention;

FIG. 3 is a fragment of a graphical user interface (GUI) for allowing a buyer to quote for one or more plants existing in different operating units and legal entities;

FIG. 4 is a fragment of a GUI for allowing a buyer to establish purchase orders for one or more plants being quoted;

FIG. 5 is a fragment of a GUI for quoting multiple supplier sites within a supplier operating unit or global enterprise;

FIGS. 6A and 6B are fragments of a GUI for allowing a supplier to add a quote detail as required;

FIG. 7 is a fragment of a GUI for allowing a supplier to submit a quote for each plant or operating unit;

FIG. 8 is a fragment of a GUI for importing a previous quotation detail into a new quotation based upon a design change or a cost change;

FIG. 9 is a fragment of a GUI for allowing control of pricing based on indices;

FIG. 10 is a fragment of a GUI for identifying cost impact over time and evaluating sourcing decisions based on changes to past decisions;

FIG. 11 is a fragment of a GUI for comparing multiple items on a single quote and to award a quote based on item and supplier relationships;

FIG. 12 is a fragment of a GUI for determining price effective dates by item or plant;

FIG. 13 is a fragment of a GUI for determining price effective dates by item or plant;

FIG. 14 is a fragment of a GUI for displaying a cost breakdown at the item level or plant level for each item; and

FIG. 15 is a fragment of a GUI for indicating if a price is temporary, i.e. interim price, and issuing a purchase order for interim price to be replaced by a firm price at a later date.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

### eRFQ Overview

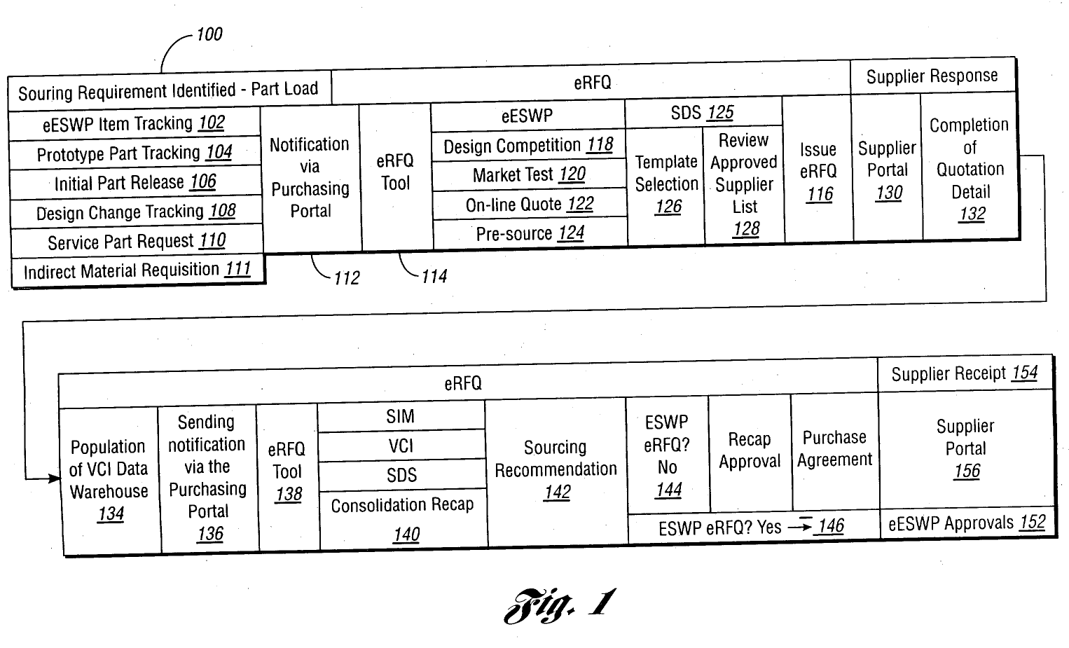

FIG. 1 is a block flow diagram illustrating an overview of an eRFQ process. Notably, the content and arrangement of objects illustrated in FIG. 1 can be rearranged, modified or omitted to best fit a particular implementation.

An eRFQ process can begin with identifying a sourcing need 100. Activities that can take place during the identification step include, but are not limited to, eESWP item tracking 102, prototype part tracking 104, initial part release 106, design change tracking 108, service part request 110, and indirect material requisition 111. eESWP, otherwise referred to as electronic early sourcing work plan, refers to a system that tracks program requirements in advance, preferably at least four years in advance. Initial part release 106 refers to the first production part release. Design change tracking 108 refers to tracking design changes once a part is in production.

After identifying the sourcing need, notifications are sent via the purchasing portal 112 to buyers that may be able to meet the sourcing need identified. eRFQ tool 114 refers to the portal commonly used by buyers to review notifications.

If the sourcing need includes an eESWP item, four different paths are contemplated by the eRFQ process in order to properly track the program requirements for the eESWP. These paths include, but are not limited to, design competition (DC) 118, market test (MT) 120, on-line quote (OLQ) 122, and pre-source (PS) 124.

The SDS 125, otherwise referred to as the strategic development system, selects a template 126 depending on the level of detail required by the buyer. The SDS also develops a sourcing strategy and identifies suppliers that are approved for sourcing. The buyer reviews the approved supplier list 128 provided by SDS.

From the approved supplier list, eligible suppliers are chosen and an eRFQ is issued to them electronically 116, via the purchasing portal 130 or e-mail. The issued eRFQ may request additional information. Before responding to the eRFQ, the supplier provides additional information in the quotation detail step 132. The supplier can send its response to the eRFQ through the purchasing portal. The buyer receives notification of the response via the purchasing portal 136.

The information in the supplier's response is used to populate the value chain intelligence data warehouse 134. The information, along with other eRFQ data is categorized in a useful format so it can be recapped or compared. The sourcing recommendation 142 is aided by eRFQ tool 138 and consolidated recap 140. eRFQ tool 138 gives the buyer the ability to recap. The information necessary for the buyer recap is supplied by the consolidated recap 140, which is supported by the supplier improvement metrics (SIM), VCI, and SDS.

The recap process includes comparing and evaluating all of the supplier's responses, including supplier's quotes, and selecting the supplier to award the business to based on the quotes.

The path to approving the sourcing recommendation depends on whether the sourcing need includes an eESWP item. If an eESWP item is not included (i.e., the sourcing need involves a current production release part or a prototype part), as represented in block 144, then the eRFQ approval process includes recap approval 148 and purchase agreement approval 150. If an eESWP item is included, the eRFQ approval process includes eESWP approval 152. A supplier receipt 154 is sent through the supplier portal 156 to the supplier who is awarded the business.

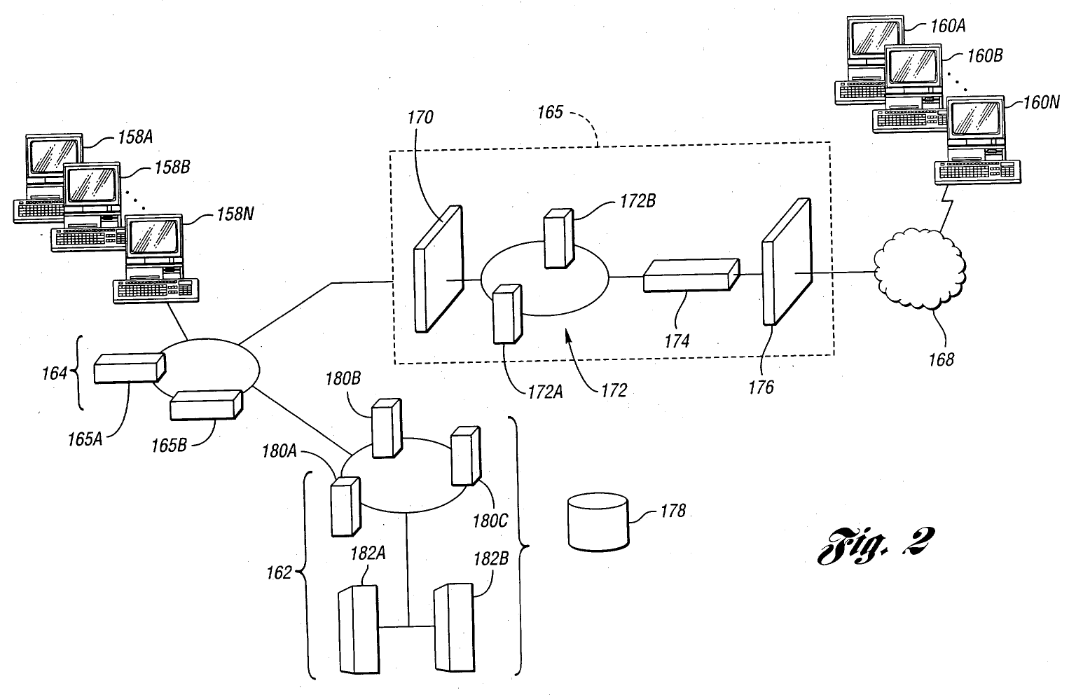

FIG. 2 is a schematic diagram illustrating a system embodiment for implementing certain embodiments of the present invention. User computers 158A-N, supplier computers 160A-N, and server configuration 162 can be interconnected through a computer network.

The computer network can include intranet 164, portal 166, and supplier network 168. Intranet 164 can be used to interconnect user computers 158A-N and server configuration 162. Intranet 164 can include at least two load balancers 165A-B. The load balancers 165A-B can be obtained commercially from Cisco Systems. Portal 166 can be used to at least partially interconnect user computers 158A-N and supplier computers 160A-N. Portal 166 can include firewall 170, at least two portal servers 172A-B, at least one load balancer 174, and firewall 176. The portal servers 172A-B can be Hewlett Packard N4000 supplier middle tier servers. Load balancer 174 can be obtained commercially from Cisco Systems.

Server configuration 162 can store information to and retrieve data from at least one database 178. Server configuration 162 can include at least three application servers 180A-C and at least two parallel servers 182A-B. The application servers 180A-C can be Hewlett Packard N4000 application servers. The parallel servers 182A-B can be Oracle parallel servers.

### eRFQ Creation Tool Functionality

An RFQ can be created in several different ways. The eRFQ can be created using part load data extracted from Material Planning and Logistics (MP&L) by the creation of a Sourcing Required Notification (SRN). The SRN can contain data such as superseding part and previous price history. Upon creating a SRN, information within the SRN may be updated as required based on triggers from MP&L including additional plants/ship to locations, volume changes, and/or design notice changes.

The eRFQ can be created manually for an existing part. When manually creating the eRFQ, data associated with the existing part can be automatically populated.

Regardless of the method for creating the eRFQ, an RFQ may include different prices and effective dates for unique plant/ship-to locations spanning across national companies (lead operating units).

After an eRFQ has been created and is in draft stage, it can be updated via triggers from MP&L.

During the stage where the eRFQ is draft and not open for supplier quotation/bids the following updates may occur additional plants/ship to locations, volume changes, and/or design notice changes.

### Quote Management Tool Functionality

The quote management tool functionality can be implemented using an interface accessible by buyers and/or suppliers.

The quote management tool functionality can be used for electronic procurement involving global suppliers. It should be understood that global suppliers refer to suppliers that operate across multiple organizations, operating units and national companies.

The quote management tool can enable a global supplier to add new lines for entry into an electronic request for quotation attribute table. For example, a sourcing need can be identified, an eRFQ can be generated based on the sourcing need, the eRFQ can be submitted to global suppliers, and the suppliers can add new lines to an eRFQ attribute table. Optionally, additional quote management tool functionality, eRFQ notification tool functionality, and eRFQ global negotiations tool functionality can be executed, as discussed in greater detail below.

The quote management tool enables a buyer to create a RFQ with one line item that provides flexibility for the supplier to respond with separate pricing for one or more assembly plant locations across one or more operating units. A buyer can define price effective dates for multiple assembly plant locations across the operating units for each part.

The quote management tool includes the ability to define flexible attributes on an eRFQ template at a header level, thereby defining data attributed common to all RFQs. In accordance with this aspect, data elements on the template can be determined at the header level. Common fields (e.g., buyer name) can be listed only once and automatically applied to all lines on the eRFQ.

The quote management tool includes the ability for a supplier to add multiple lines to an attribute. Additionally, the tool can aggregate/calculate the total multiple attributes within a line. This functionality allows a supplier to add multiple lines to an attribute (e.g., tooling detail). This provides a master detail relationship between the attribute and the attribute line. The buyer can control the attribute and the suppliers possess the ability to respond with lines as required. Accordingly, a supplier can respond at the attribute level or add supporting attribute detail as required. Costing at the attribute line detail rolls up to the attribute level for analysis purposes. As a buyer evaluates quotes from suppliers, the buyer can drill into the attribute line detail as required. Additionally, buyers can define multiple cost element types (cost categories, on the eRFQ in addition to the item unit price, and request that suppliers respond to the costs through the bidding process). This functionality has the ability to calculate the costs of attributes based on attribute relationships.

The quote management tool includes the ability to group attributes based on attribute relationships. This functionality enables a buyer to determine a grouping of elements upon a template used by both the buyer and supplier. This functionality provides a more organized view and path to complete the template for both parties.

The quote management tool includes functionality for identifying changes between versions of quotations by supplier. This aspect enables a buyer to view changes between a supplier's quote and a single round. This feature enables a buyer to identify what changes have been made from one version of a supplier's quote to the next. When a buyer initiates a new round of quotation, prior quote information is copied from the last set of quotes. The buyer can update and create a new quote. Information may be retained for later analysis.

The quote management tool includes the ability to import the previous quotation detail into the quotation for the new item when quoting items have gone through a design change. Therefore, the supplier quotes only the changes or variances from the previous item design.

The quote management tool includes the ability to source parts by assembly plant locations across operating units. The buyer can to source by ship-to locations within a RFQ. The buyer can select the appropriate ship-from location for each ship-to location.

The quote management tool includes functionality for requisitioner-initiated purchase order amendment request. This functionality includes the ability to support issuance of an RFQ from a requisitioner's purchase order amendment request. A new RFQ can be created for a new demand that has been added to an existing requisition.

The quote management tool includes functionality for suppliers to submit multiple quotations per response (e.g., options A, B, and C).

The quote management tool include functionality for handling a component level bill of materials. A buyer can set up an RFQ with a line item representing the component level bill of materials, and define the sub-components as relational attributes to the line item. The supplier can place the quotation at the component level and view the sub-components online, as captured by the buyer. Quote pricing by the supplier may be made at the component level and aggregation at the line level.

The quote management tool can include the functionality to issue RFQs for sub components related to a component. The functionality should allow the quotation of a lead component to a Tier 1 global supplier and the quotation of a sub-component to a Tier 2 global supplier. A relationship between the two components and RFQs should be maintained. This relationship should also be maintained within the Purchase Agreements once the quotations are approved within the quote management tool.

The quote management tools includes the ability to approve an eRFQ recap based on multiple approval hierarchies. Multiple approval hierarchies can be defined by an organization (e.g., requisitioner, approval of quotation, or manager approval of quotation based on business value).

The quote management tool includes the ability for the supplier to quote items based on index pricing referred to as Automatic Materials. Automatic materials include materials purchased on the external commodities market which regularly vary in price. The automatic material functionality enables buyers to set up agreed parts so that price changes will be processed automatically.

When providing a quotation, the supplier should have the ability to indicate materials that will be priced according to an index. The index value can be validated when applied by the supplier. The piece price of parts which contain these materials can be adjusted according to the index price. When providing an index code, date, and UoM, the tool should validate the index value and calculate the value of the indexed material and determine the appropriate cost. When an item is priced according to the index, the tool should allow for the update of purchase order prices according to the appropriate index cost.

### eRFQ Recap Tool Functionality

The eRFQ recap tool functionality can be used for electronic procurement involving global suppliers.

The eRFQ recap tool enables a global buyer to compare a first quotation and a second quotation submitted by global suppliers. For example, an eRFQ can be submitted to a first and second global supplier, suppliers can create quotations for the eRFQ, the quotations are received and can be compared through an eRFQ recap interface.

The eRFQ recap tool includes the ability to calculate annual total dollar impact of business awarded to a supplier.

The eRFQ recap tool includes the ability to calculate the variance between the previous approved PO/part cost and a quotation.

The delegation of authority for carryover sourcing is based on cost variance analysis which is comprised of the summation of: production part price variance from the previous price and the volume supplied summed per supplier per plant, tooling price summed per supplier, and prototype part price variance from the previous price and the quotient of the volume supplied and number of national companies and suppliers summed per national company per supplier.

The delegation of authority for non-carryover sourcing is based on total annual cost analysis which is comprised of the summation of: production part price (which may include a duty uplift and freight cost) and volume supplied summed per plant per supplier, tooling price summed per supplier, and prototype part price and the quotient of the volume supplied and number of national companies and suppliers summed per national company per supplier.

The eRFQ recap tool includes the ability to allow comparison of quotations submitted from multiple global suppliers at the line level. The buyer has the ability to compare individual quotation line items submitted from multiple suppliers in one view. The buyer can compare two or more quotations by line item.

The eRFQ recap tool includes the ability to compare all line items for global suppliers at once. The buyer can compare all quotation line items submitted from multiple global suppliers in one view. This functionality may be dependent upon the amount of suppliers submitting quotations and the amount of data elements that may be displayed on one user interface view.

The eRFQ tool functionality includes the ability for the buyer to determine the PO effective date at the time of approval. The buyer has the ability to establish a BPA effective date at the time of Recap award. This date can be prior or post to the current system date. This PO date may reflect the date of PO at the header level and may not reflect the effective date(s) for each PO line.

The eRFQ recap tool includes the ability for the buyer to determine sourcing by plant across multiple operating units. This function may be carried over from the creation of an RFQ either from a part load or a manual process. The buyer has the ability to edit or modify the sourcing per assembly plant. One supplier “ship from” site may have the ability to source multiple “ship to” sites across multiple operating units.

The eRFQ recap tool includes the ability for the buyer to determine pricing by plant across multiple operating units. The eRFQ and Recap have the ability to invoke pricing per plant from one supplier. If this is a carry over price or roll of plant then this may be carried over from the creation of the eRFQ either from the part load or the manual process. The buyer has the ability to edit or modify the pricing per assembly plant.

The eRFQ tool includes the ability for buyers to store recap drafts. The buyer can save recap drafts once the buyer approves the quotation from the global supplier.

The eRFQ recap tool includes the ability for the buyer can approve a quotation from a global supplier for all lines associated to a recap. The recap user interface contains a button to initiate the award and subsequently initiate a delegation of authority workflow when an award is above the buyer's authority.

The eRFQ recap tool includes the ability to enter justification documentation for approval or rejection of a quotation from a global supplier and the ability to retain this data for a pre-defined retention period. The approver may have the ability to enter comments to the buyer's justification comments or have a separate text block for entering approval or rejection comments. This comment text can be only available to internal (buyer) users and not available to suppliers.

The eRFQ recap tool includes the ability the buyer to revise a sourcing justification after an approval of a quotation from a global approver within the designated approval hierarchy. The buyer has the ability to define and store award justification information subsequent to rejection by an approver. The buyer may resubmit the Recap for awarding to the approver after they have updated their justification text.

The eRFQ recap tool includes an automatic materials feature. Automatic materials include materials purchased on the external commodities market which regularly vary in price. The piece price of parts which contain these materials can be adjusted. The automatic material functionality enables buyers to set up agreed parts so that price changes will be processed automatically.

The recap process can be initiated after RFQs have been sent to the selected supplier base and the supplier quotations have been submitted. Upon selecting a quotation for approval, the DOA process can be initiated if the value amount exceeds the buyer's authority. Upon completion of this process, a BPA may be approved and generated or a tooling order may be created in an “incomplete” status pending further approvals.

During the recap process, the Delegation of Authority (DOA) can be based on the impact on turnover. DOA can be applied at the time of awarding the quote. A link may be provided on the Recap UI to initiate this process.

During the recap process, the buyer can determine if a purchase order (PO) or a tool order (TO) should be automatically issued after approval by the appropriate level. The buyer has the ability to delay the issuance of the PO at time of Recap award. Default may be that the BPA is automatically issued upon approval (based on PO approval hierarchy), but a mechanism may be provided to flag the BPA or line items for delaying the issuance of the BPA or line item until a later date. This could be a normal occurrence when tooling is involved for the order. The item or tooling item may require to be issued prior to all items on the PO being released.

Data attributes, otherwise known as data elements, can be included in the Recap. Data elements can be included in the Recap that can be manually updated by the buyer during the Recap process and prior to awarding the quote or submitting the quote for approval. Examples of such data elements include: sourcing justification remarks, a PO effective date, and notes to suppliers, etc.

### eRFQ Notifications Tool Functionality

The eRFQ notifications tool provides a buyer access to work items via a buyer workbench. From the workbench, the buyer can select from notifications provided by eRFQ and take the appropriate action within the eRFQ business process.

An Oracle workflow management system handles the generation and closure of items based upon defined business process flows. Closure of a notification removes that notification from the buyer workbench.

In a supplier portal, a link to an eRFQ homepage can be provided. At the homepage the supplier may view a notifications list. The list may provide the supplier a means to view work items to be completed. By opening a notification the supplier launches the eRFQ application. The buyer can complete their quotation and submit the quotation to the buyer.

Closure of notifications for the supplier can be maintained through the automation and manual closure of notifications. Closure of a notification can remove that notification from the supplier workbench.

One notification generated can be a “Sourcing Required” notification. This is a notification to buyer that a sourcing required request has been received from part load. The buyer may be presented with a sourcing required notification detailing the critical information required to determine the next step in the business process (e.g., create eRFQ, no action, source only, etc.).

When a buyer chooses to create an RFQ, an eRFQ tool can be launched and the header of the eRFQ can be populated with the data provided by part load. Within the eRFQ tool the buyer has the option to select from a list of predefined RFQ templates.

When a buyer chooses no action, the sourcing data can be stored for optional RFQ creation at a later date. This selection allows the buyer to access a pull down menu with a list of causes indicating why the part was not acted upon. Casual codes allow for tracking of no action notifications. This information can be used for analysis to improve future performance. One no action code is “V” indicating that volume has changed, but did not require action. Another no action code is “P” indicating a plant change or addition that did not require action. Another no action code is “N” indicating that a part will not be utilized in production and, therefore, no action was required. Another no action code includes “I” indicating that no further action could be taken because the information provided was incomplete.

When the buyer selects the source only option, a sourcing response is sent without issuing an RFQ. The carryover source may be pulled with a part detail and brought in by part load.

The following information may be included in “sourcing required” notification: buyer identification information or code, date for first program job, date the notification was created, a reference number for the notification, a commodity code/description, a code indicating why the request for sourcing has been generated, engineering drawing levels, product/part description or codes, part number, previous part number, previous piece price for a part, amount of tooling that has been paid, a program code, number of prototype parts required, assembly plant location for the part/product, sourcing approach, unit of measure, service part number, weekly normal volume by plant, total weekly normal weekly volume (e.g., total for all plants, etc.), and annual financial planning volume. A comment field may additionally be included in the “sourcing required” notification.

Another notification generated can be a “RFQ in Process” notification. This notification details to a buyer that an RFQ has been created and is in the process of being completed. Another notification includes a “Quote Required” notification. This is a notification to a buyer that an RFQ has been issued to a supplier and is now awaiting a response. Another notification is a “Request for Quote” notification to a supplier requesting a quotation. A link can be provided in this notification to enable the supplier to open/view the eRFQ.

Another notification can be a “RFQ Closed” notification to a buyer that a RFQ close date has passed. If all responses have been received prior to the close date, the eRFQ may remain open until the buyer takes action and generates a recap. Buttons/links may be provided enabling the buyer to generate a recap for the eRFQ or extend the eRFQ closed date. Another “RFQ Closed” notification notifies a supplier that an RFQ close date was reached without a quote being received.

Other types of notifications include “Early Close”, “RFQ Cancelled”, “Quote Disqualified”, “Quote Received”, “No Quote” (where supplier decides not to participate in the quoting round), “Recap in Process”, “Approval Rejected” (including a link/button to open the recap), “Approval Pending”, “Approval Required” (including a link/button to open the recap), and “PO Issuance Required” where a recap has been approved and a PO is now awaiting issue to supplier.

### eRFQ Global Negotiations Tool Functionality

The eRFQ global negotiations tool includes an upstream activity for creating global request for quotes. This global request for quotes can be initiated by a Material Planning and Logistics (MP&L) group providing a part load extract. eRFQs can also be created manually.

The eRFQ global negotiations tool enables sourcing of parts by assembly plant locations across distributed operating units and allows for a single ship-from location from a single supplier manufacturing site. Extensions to this process provide information including a PO header detail across operating units, price break detail information by line item including piece price and price effective dates, and ship-from locations. These extensions enable both the buyer and the global supply base to submit and respond to eRFQs in a timely electronic manner via a web browser.

The eRFQ global negotiations tool includes the ability to source parts by assembly plant locations across operating units (e.g., global negotiations). This feature allows part load/buyer to create an RFQ from the ATP with one line item that provides flexibility for the supplier to respond with separate pricing for each assembly plant location across operating units. The supplier can respond with separate pricing for each assembly plant location across operating units for each part. The buyer can determine price effective dates for each assembly plant location across operating units for each part.

### Implementation of the eRFQ Tool Functionality

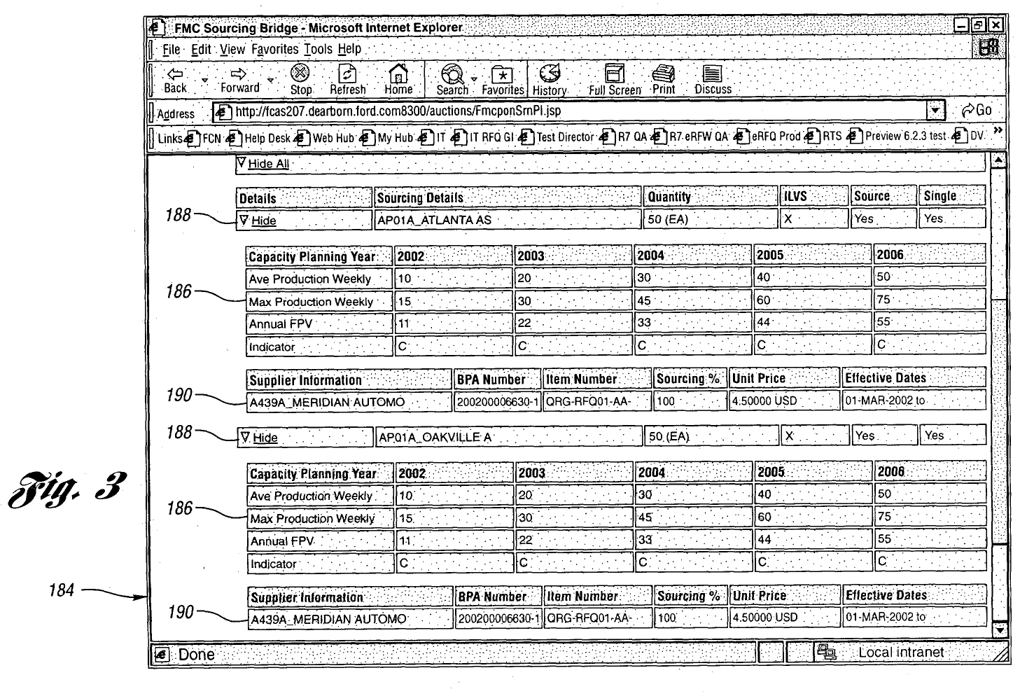

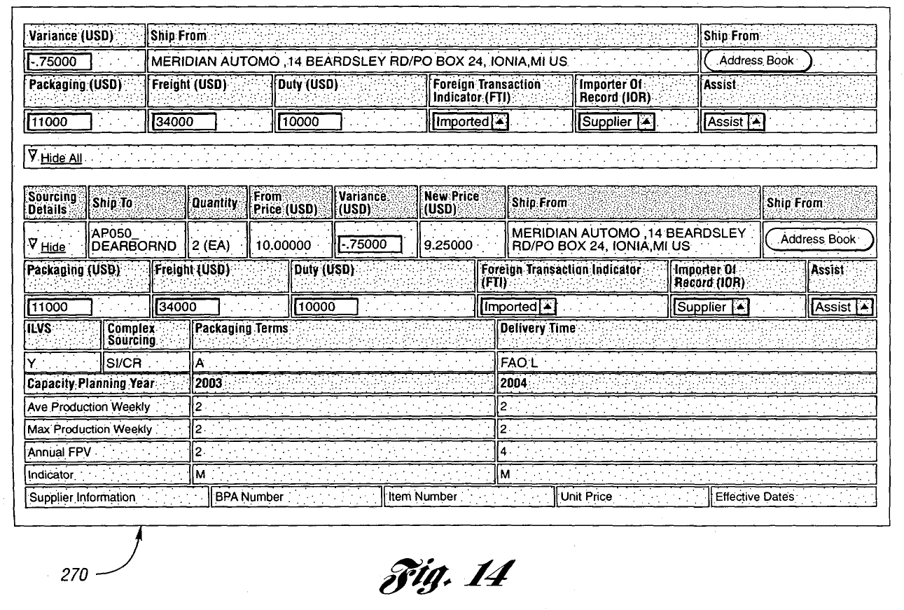

In certain embodiments, the above-mentioned tools can be implemented using Procurement software, and in some instances, Oracle Procurement software. FIGS. 3 through 16 depict an example of implementation of the tool functionality through Oracle Procurement software. It should be understood that the implementation depicted can be modified and rearranged to best fit a particular embodiment of the present invention.

FIG. 3 is a fragment of a graphical user interface (GUI) for allowing a buyer to quote for one or more plants existing in different operating units and legal entities. GUI 184 includes carryover quotation information from a supplier, A439A_MERIDIAN AUTOMO, for two plants, AP01A_ATLANTA AS and AP20A_OAKVILLE A. The quotation information can be displayed in the format of tables 186 having columns for entering or displaying planning years and rows for entering or displaying capacity numbers. Capacity numbers can be included for average production weekly, maximum production weekly, and annual FPV. Plant sourcing information 188 can be included on GUI 184, for example, details, sourcing details, quantity, ILVS, source, and single. Moreover, supplier information 190, including, but not limited to, BPA number, item number, sourcing percentage, unit price, and effective date, can be displayed or edited on GUI 184.

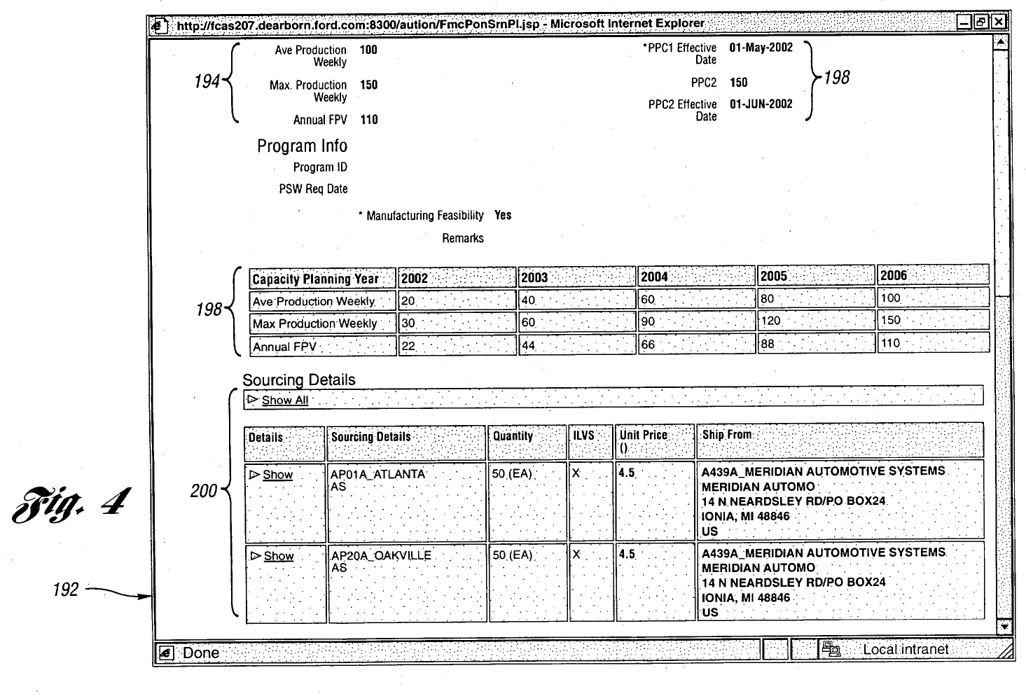

FIG. 4 is a fragment of a GUI for allowing a buyer to establish purchase orders for one or more plants being quoted. GUI 192 can include capacity information 194, capacity planning information 198 and sourcing details 200. Capacity information 194 can include, but are not limited to, average production weekly, maximum production weekly, and annual financial planning values (FPV). Capacity planning information 198 can include one or more effective dates, average production weekly, maximum production weekly, and annual FPV values for one or more planning years. Sourcing details 200 can include, but is not limited to, plant name, quantity, in-line vehicle sequencing (ILVS), unit price and ship from location. The supplier has the ability to input the unit price into sourcing details 200.

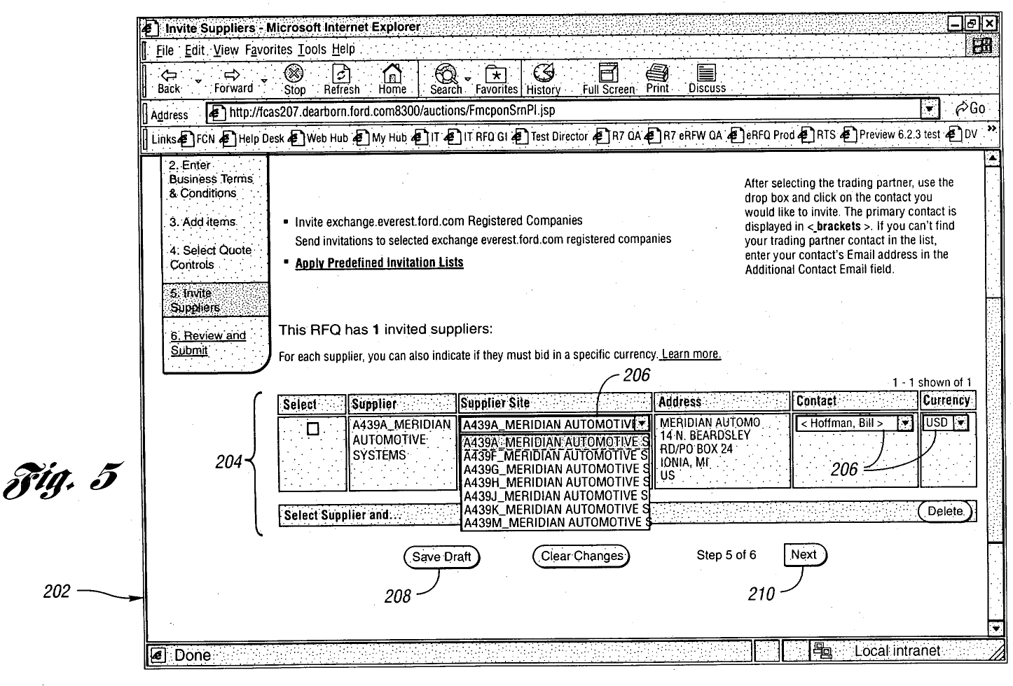

FIG. 5 is a fragment of a GUI for quoting multiple supplier sites within a supplier operating unit or global enterprise. GUI 202 includes table 204 for adding a supplier for invitation. Table 204 includes the supplier name and address and drop down boxes 206 for supplier site, contact, and currency. The supplier can modify the supplier site, contact, and currency through drop down boxes 206. When the buyer is satisfied with the changes, the buyer can click on save draft button 208 and proceed to the next step in the RFQ process by clicking on the next button 210.

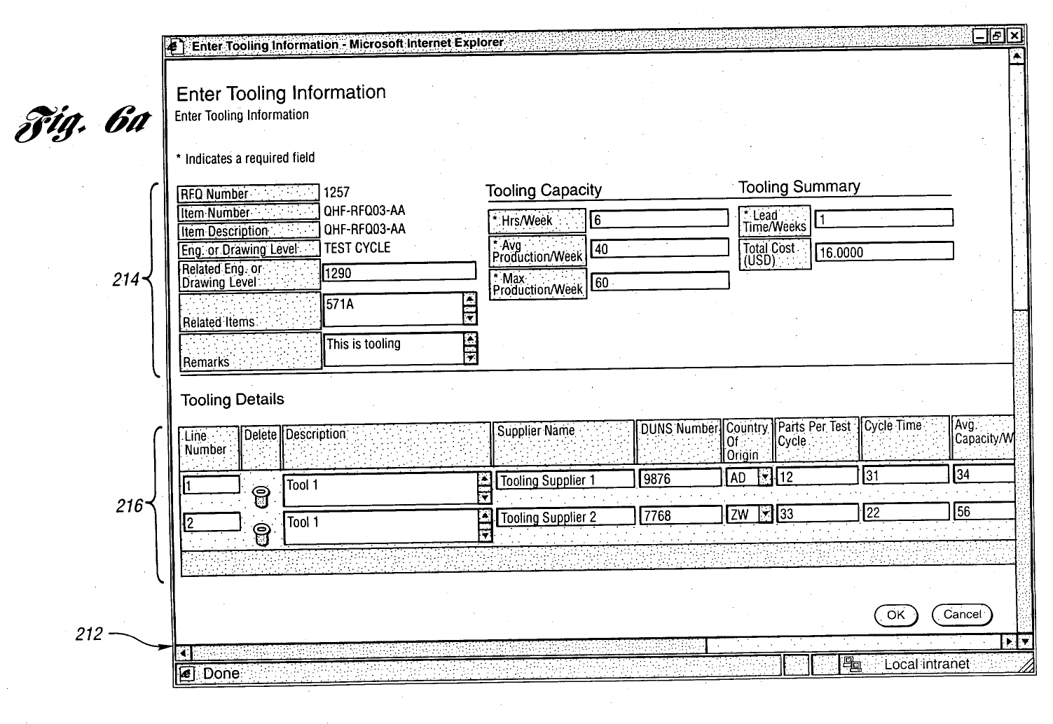

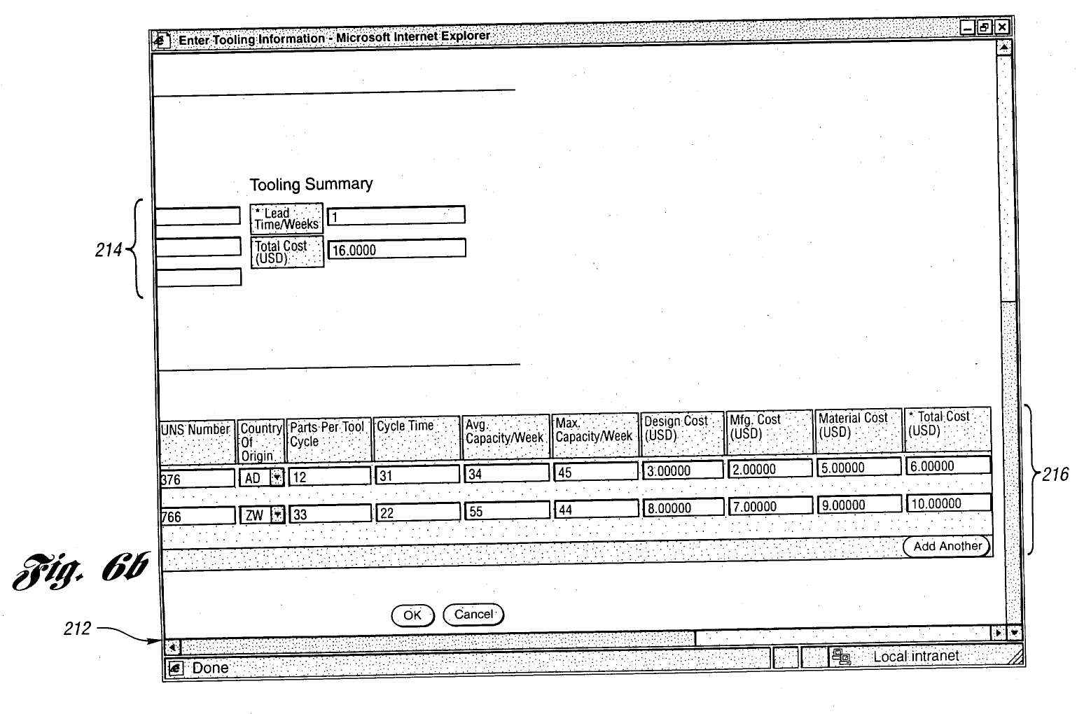

FIGS. 6A and 6B are fragments of a GUI for allowing a supplier to add a quote detail as required. GUI 212 includes section 214 for entering tooling information regarding an eRFQ. Section 214 includes information, for example, RFQ number, item number, item description, and engineering or drawing level, for identifying the eRFQ that requires addition of the quote detail. Data input boxes are provided in section 214 for related engineering or drawing level, related item, remarks, tooling capacity (hours per week, average production per week, and maximum production per week), and tooling summary (lead time per weeks and total cost). Section 216 of GUI 212 includes one or more line items for entering tooling details, which can include data input boxes for entering description, supplier name, DUNS number, country of origin, parts per tool cycle, cycle time, average capacity per week, maximum capacity per week, design cost, manufacturing cost, material cost, and total cost.

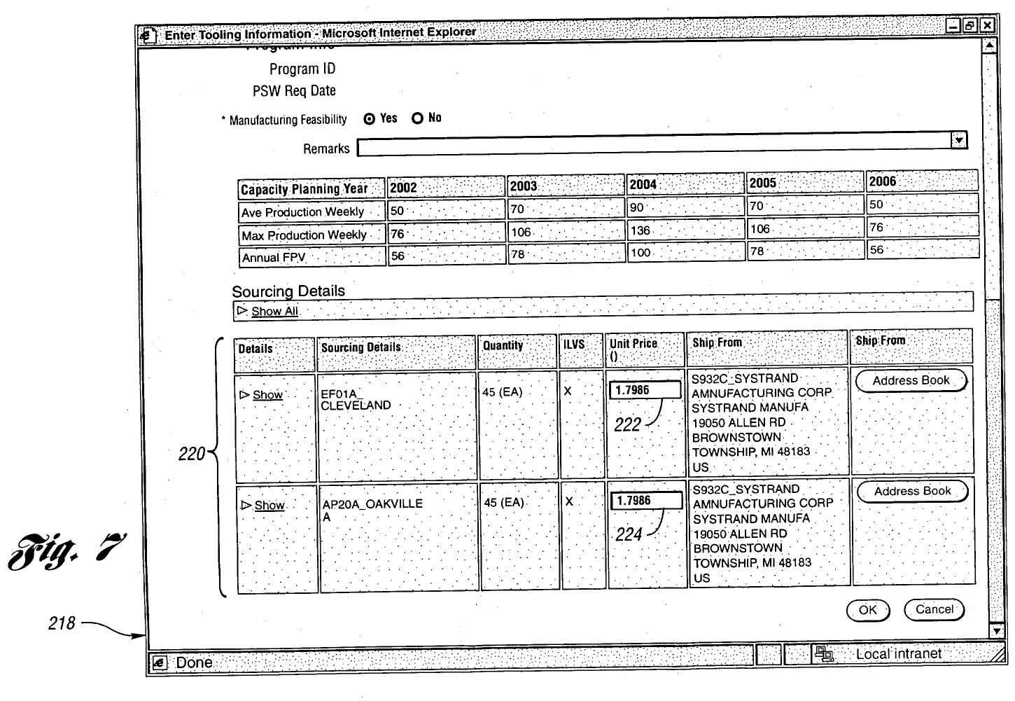

FIG. 7 is a fragment of a GUI for allowing a supplier to submit a quote for each plant or operating unit. GUI 218 includes table 220 for reviewing and entering quote information for each plant or operating unit. The information can include, but is not limited to, quantity, ILVS, unit price, and ship from location for each plant or operating unit. Notably, the supplier can submit a unit price in data input boxes 222 and 224, for a first and second plant, respectively.

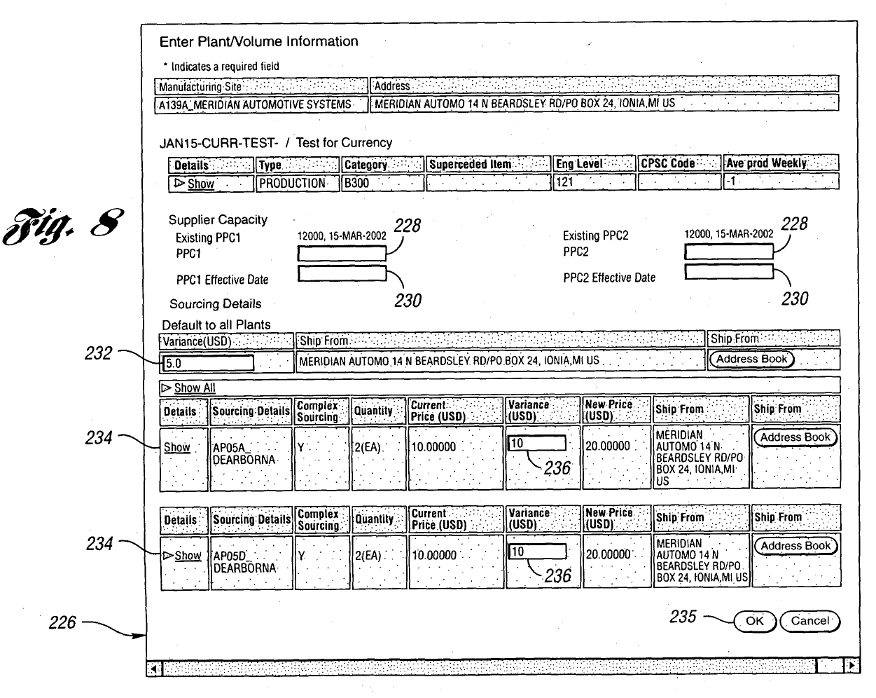

FIG. 8 is a fragment of a GUI for importing a previous quotation detail into a new quotation based upon a design change or a cost change. GUI 226 includes several data input boxes for entering plant/volume information. For example, data input boxes can be displayed for supplier capacity 228 and effective dates 230 and variance default 232 for all plants. GUI 226 can also include line items 234 for entering quotation information with respect to a design change or a cost change. Notably, data input boxes 236 can be used to input the cost variance for the two line items depicted on FIG. 8. Moreover, each line item can include, but is not limited to, the following information: sourcing details, complex sourcing, quantity current price, new price (which takes into account the variance), and ship from location. After a user enters the applicable price detail information, OK button 235 can be clicked to finish the step of importing previous quotation detail into a new quotation.

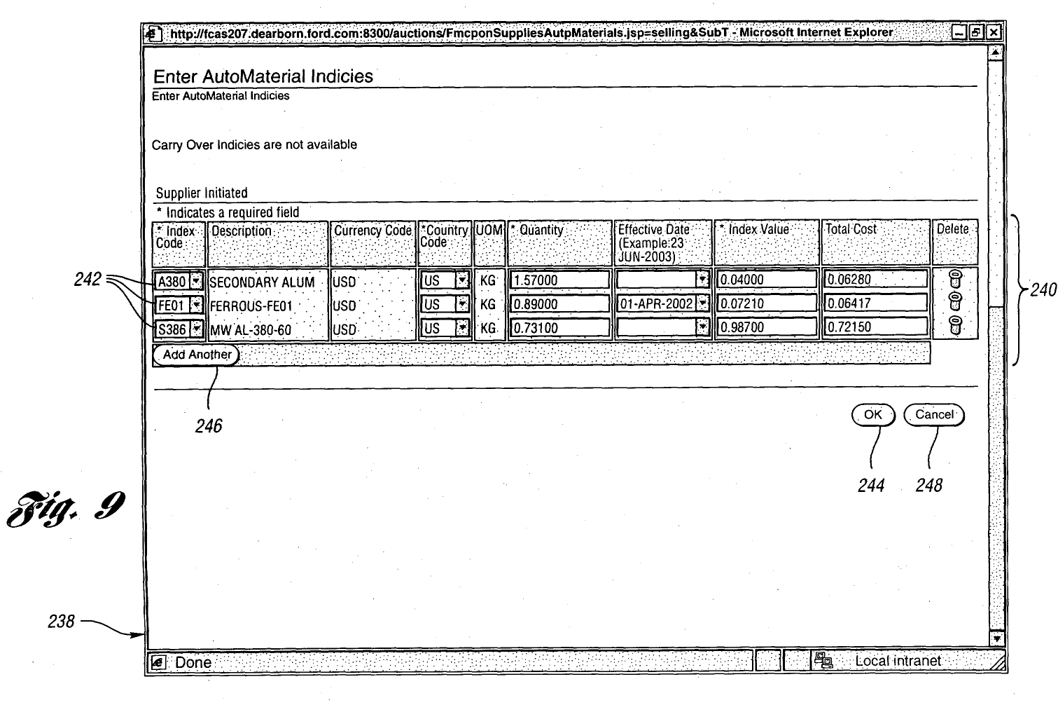

FIG. 9 is a fragment of a GUI for allowing control of pricing based on indices. Notably, pricing can be adjusted for each change in an index value. GUI 238 includes an index value table 240 with one or more index lines 242. Each index line 242 includes a number of data input boxes and description fields. Examples of data input boxes include index code, country code, quantity, effective date, index value, and total cost. Examples of description fields include description, currency code, and unit of measure. When the user completes filling in at least the required input boxes, the OK button 244 can be selected to complete a price adjustment. Moreover, the user can add new index lines by clicking on the “add another” button 246. GUI 238 also includes cancel button 248 for cancelling out of the price adjustment step.

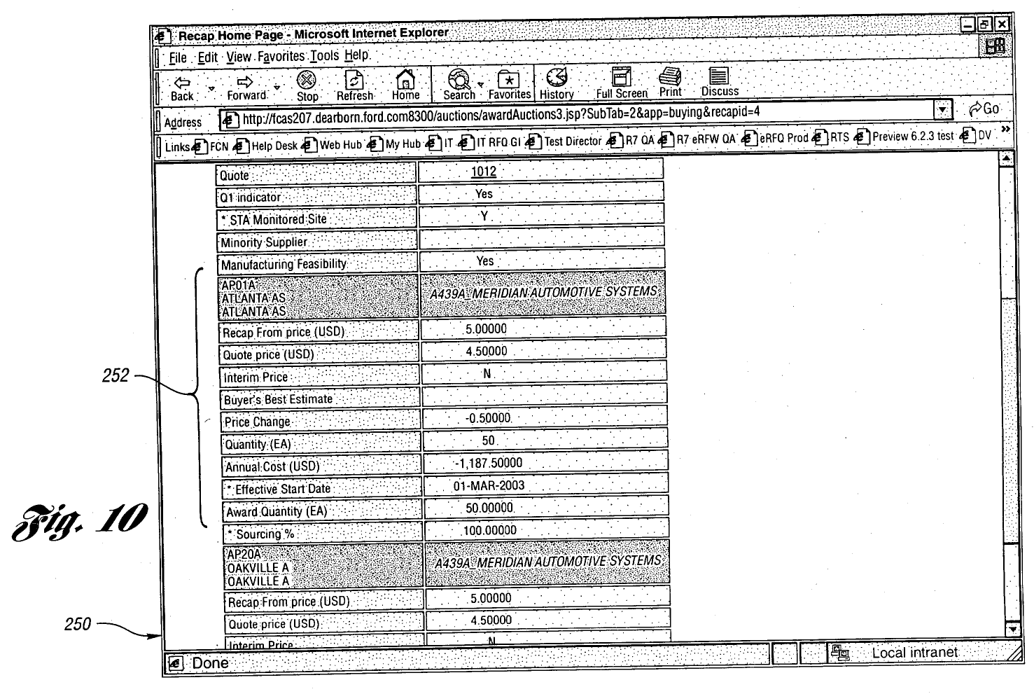

FIG. 10 is a fragment of a GUI for identifying cost impact over time and evaluating sourcing decisions based on changes to past decisions. GUI 259 can include one or more cost impact tables 252, which identifies a plant name and a supplier name. Each cost impact table 252 also includes several pieces of information relevant to cost impact analysis, including, but not limited to, recap from-price, quote price, interim price, buyer's best estimate, price change, quantity, annual cost, effective start date, award quantity, and sourcing percentage.

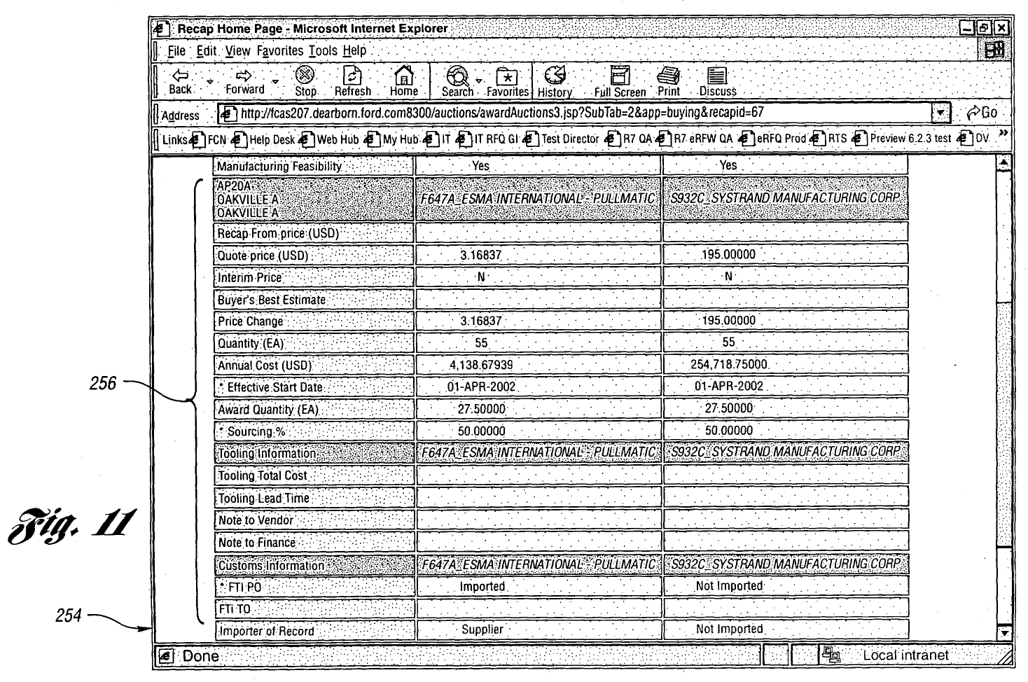

FIG. 11 is a fragment of a GUI for comparing multiple items on a single quote and to award a quote based on item and supplier relationships. GUI 254 includes table 256 containing quotation information for two or more suppliers in order to compare and award the quotation. As depicted in FIG. 11, quotation information for providing a part to plant, OAKVILLE A, from two suppliers, F647A_TESMA INTERNATIONAL-PULLMATIC and S932C_SYSTRAND MANUFACTURING CORP, is provided. The quotation information can include, but is not limited to, recap from-price, quote price, interim price, buyer's best estimate, price change, quantity, annual cost, effective start date, award quantity, sourcing percentage, tooling information (such as tooling total cost, tooling lead time, mote to vendor, and note to finance), and customs information (such as importer of record).

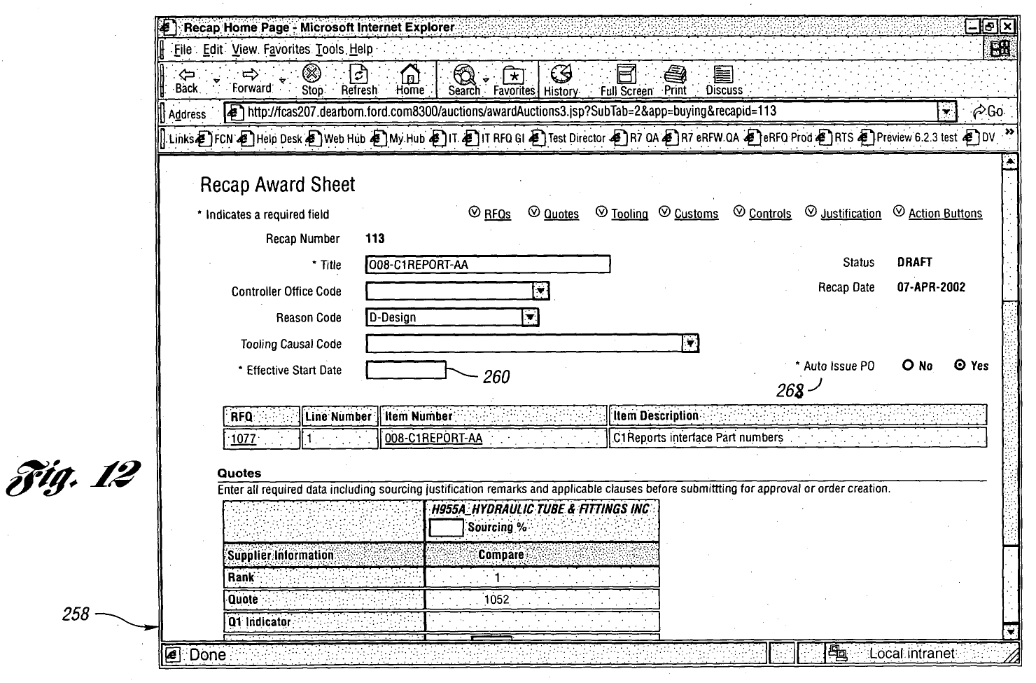

FIG. 12 is a fragment of a GUI for determining price effective dates by item or plant. Notably, GUI 258 includes data input box 260 for entering an effective start date. GUI 258 can also include several other data input boxes and pieces of information. For example, GUI 258 can include data input boxes for title, controller office code, reason code, tooling casual code, effective start date and sourcing percentage. Information displayed on GUI 258 can include, but is not limited to, recap number, status, recap date, RFQ number, line number, item number, and item description.

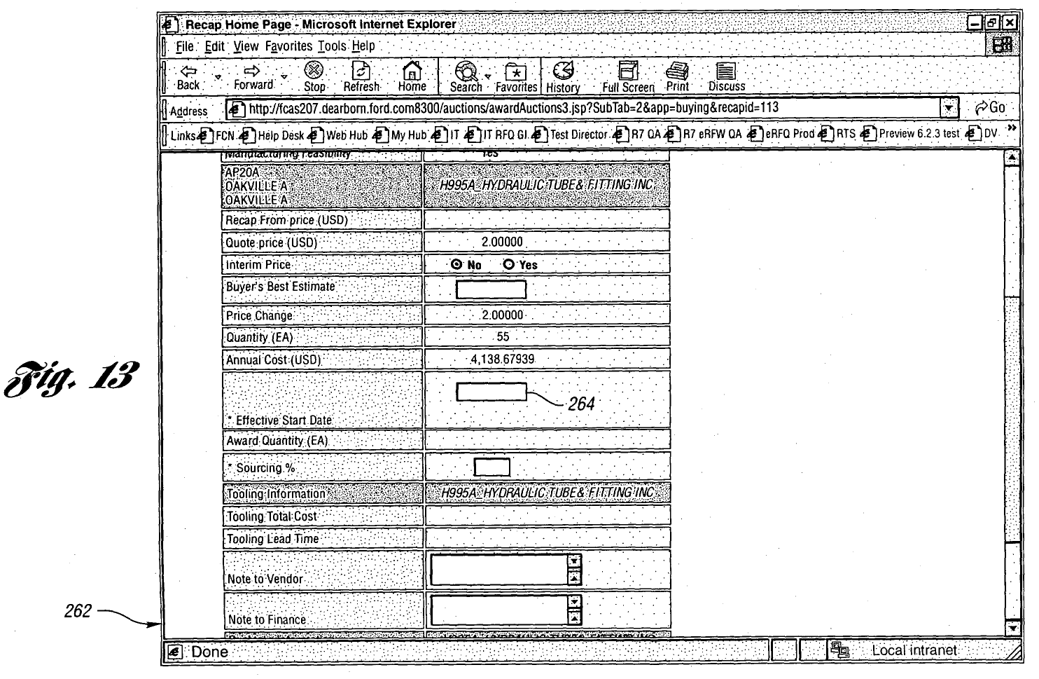

FIG. 13 is a fragment of a GUI for determining price effective dates by item or plant. Notably, GUI 262 includes data input box 264 for entering an effective start date. Other data input boxes can be displayed on GUI 262. Examples include data input boxes for buyer's best estimate, sourcing percentage, note to vendor, and note to finance. GUI 262 can also include the following information: quote price, interim price, price change, quantity, award quantity, tooling total cost (if available), and tooling lead time (if available).

Referring again to FIG. 12, GUI 258 accomplishes the task of controlling release by providing radio button 268 for auto issue purchase order. The user can select either yes or no from radio button 268.

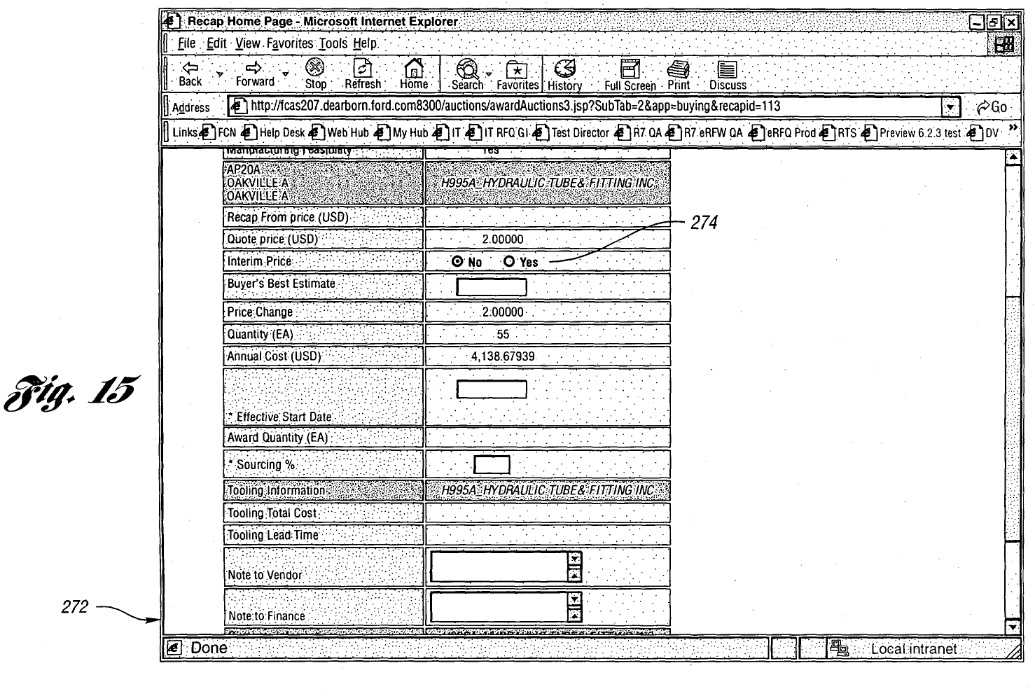

FIG. 15 is a fragment of a GUI for displaying a cost breakdown at the item level or plant level for each item. GUI 270 can include sourcing details, for example, ship to location, quantity, from price, variance, new price, and ship from location. A data input box can be provided for adjusting the variance. GUI 270 can also include data input boxes for packaging, freight, duty, foreign transaction indicator, importer of record, and assist. GUI 270 can also include packaging and delivery terms broken down into capacity planning year, average production weekly, maximum production weekly, annual FPV, and indicator.

FIG. 16 is a fragment of a GUI for indicating if a price is temporary, i.e. interim price, and issuing a purchase order for interim price to be replaced by a firm price at a later date. Notably, GUI 272 includes interim price radio button 274.

While the best mode for carrying out the invention has been described in detail, those familiar with the art to which their invention relates will recognize various alternative designs and embodiments for practicing the invention as defined by the following claims.

What is claimed:

1. A computer-implemented method for electronic procurement for multiple plants involving electronic requests for quotation, the method comprising:
receiving sourcing information, the sourcing information including a part description for a part and a first and second plant description for a first and second plant needing the part, the first and second plants existing in a first and second operating unit, respectively;
transmitting the sourcing information to one or more buyers;
transmitting an electronic request for quotation (eRFQ) based on the sourcing information to one or more suppliers, the eRFQ including an attribute table, and the attribute table including at least one line item; and
receiving one or more quotations for the part being potentially supplied to the first and second plants from each of the one or more suppliers through a quote management tool interface, each of the one or more quotations can include a first part price for supply to the first plant and a second part price for supply to the second plant, the first and second part prices can be different.

2. The method of claim 1 further comprising creating a first and second purchase order for the first and second plants needing the part based on the electronic request for quotation and the one of more quotations.

3. The method of claim 1 wherein one of the one or more suppliers is comprised of a supplier operating unit, the supplier operating unit is comprised of two or more supplier sites, the electronic request for quotation being transmitted to the two or more supplier sites, the two or more supplier sites transmitting an at least first and second supplier site quotation to the one or more buyers.

4. The method of claim 1 wherein the quote management tool includes functionality for adding at least one new line item to the attribute table.

5. The method of claim 1 further comprising transmitting a revised eRFQ based on the sourcing information and the one or more quotations to the one or more suppliers, the revised eRFQ including a revised attribute table, the attribute table including at least one revised line item.

6. The method of claim 5 further comprising receiving one or more revised quotations for the part being potentially supplied to the first and second plants from each of the one or more suppliers through the quote management tool interface.

7. The method of claim 6 further comprising causing display of the one or more quotations and the one or more revised quotations.

8. The method of claim 1 further comprising at least partially importing the attribute table from the eRFQ into a revised eRFQ if the part has gone through a design change.

9. The method of claim 1 wherein each of the one or more suppliers transmits two or more quotations for the part being potentially supplied through the quote management tool interface.

10. The method of claim 1 wherein the quote management tool includes functionality to receive an approval of an eRFQ recap based on two or more approval hierarchies.

11. The method of claim 1 wherein the eRFQ includes an at least one index price.

12. The method of claim 11 wherein the part price is adjusted automatically based on the at least one index price.

13. The method of claim 1 further comprising determining a price effective date for the part, the first plant, and/or the second plant.

14. The method of claim 1 wherein the attribute table includes a cost breakdown.

15. The method of claim 14 wherein the cost breakdown includes a duty uplift price and a freight cost.

16. The method of claim 14 wherein the cost breakdown includes a volume supplied per plant per supplier and a tooling price per supplier.

17. The method of claim 1 further comprising receiving an interim price onto the at least one line item.

18. The method of claim 17 further comprising issuing a purchase order based on the interim price.

19. The method of claim 18 further comprising replacing the interim price with a firm price.

20. A computer-implemented method for component level electronic procurement involving electronic requests for quotation, the method comprising:
receiving sourcing information for a lead component and one or more sub-components, the sourcing information including a part description for the lead component and the one or more sub-components;
transmitting the sourcing information to one or more buyers;
transmitting an electronic request for quotation (eRFQ) based on the sourcing information to one or more tier one suppliers and one or more tier two suppliers, the eRFQ including an attribute table, and the attribute table including at least one line item; and
receiving one or more quotations for the lead component and the one or more sub-components being potentially supplied from each of the one or more tier one suppliers for the lead component and each of the one or more tier two suppliers for the one or more sub-components through a quote management tool interface.

21. The method of claim 20 wherein the relationship between the lead component and the one or more sub-components are defined as one or more component attributes to the at least one line item.

22. The method of claim 21 further comprising maintaining a component-level bill of materials based on the attribute table.

23. A computer-implemented method for electronic procurement involving electronic requests for quotation, the method comprising:
receiving sourcing information, the sourcing information including a part description for a part and a plant description for an at least one plant needing the part;
transmitting the sourcing information to one or more buyers;
transmitting an electronic request for quotation (eRFQ) based on the sourcing information to a first and second supplier, the eRFQ including an attribute table, and the attribute table including at least one line item; and
receiving a first quotation for the part being potentially supplied to the plant from the first supplier through a quote management tool interface, the first quotation including a first quotation price;
receiving a second quotation for the part being potentially supplied to the plant from the second supplier through the quote management tool interface, the second quotation including a second quotation price; and
causing display of the first and second quotations through an eRFQ recap tool interface for comparing the first and second quotations.

24. The method of claim 23 wherein the eRFQ recap tool interface includes functionality to determine an annual total dollar impact for parts supplied by the first and/or second supplier.

25. The method of claim 23 further comprising receiving a price variance for the part and causing display of a carryover part price based on the variance.

26. The method of claim 25 wherein the first and second suppliers quote based on the variance.

27. The method of claim 26 wherein the eRFQ recap tool interface includes functionality to create a recap based on the carryover part price and causing display of the carryover part price and the variance.

28. The method of claim 23 wherein the eRFQ recap tool interface includes functionality to cause comparison of the first and second quotations through the at least one line item.

29. The method of claim 25 wherein the eRFQ recap tool interface includes functionality to receive an order issue for the selected supplier, the order issue being a purchase order or a tool order.

30. A computer-implemented system for electronic procurement for multiple plants involving electronic requests for quotation, the system comprising at least one server computer for communicating with at least one client computer, the at least one server computer being configured to:
receive sourcing information, the sourcing information including a part description for a part and a first and second plant description for a first and second plant needing the part, the first and second plants existing in a first and second operating unit, respectively;
transmit the sourcing information to one or more buyers;
transmit an electronic request for quotation (eRFQ) based on the sourcing information to one or more suppliers, the eRFQ including an attribute table, and the attribute table including at least one line item; and
receive one or more quotations for the part being potentially supplied to the first and second plants from each of the one or more suppliers through a quote management tool interface, each of the one or more quotations can include a first part price for supply to the first plant and a second part price for supply to the second plant, the first and second part prices can be different.

31. A program for controlling a computer of a server electronic procurement for multiple plants involving electronic requests for quotation, the program comprising:
instructions for receiving sourcing information, the sourcing information including a part description for a part and a first and second plant description for a first and second plant needing the part, the first and second plants existing in a first and second operating unit, respectively;
instructions for transmitting the sourcing information to one or more buyers;
instructions for transmitting an electronic request for quotation (eRFQ) based on the sourcing information to one or more suppliers, the eRFQ including an attribute table, and the attribute table including at least one line item; and
instructions for receiving one or more quotations for the part being potentially supplied to the first and second plants from each of the one or more suppliers through a quote management tool interface, each of the one or more quotations can include a first part price for supply to the first plant and a second part price for supply to the second plant, the first and second part prices can be different.
